(19) United States
(12) Patent Application Publication
(10) Pub. No.: US 2014/0290261 A1
(43) Pub. Date: Oct. 2, 2014

(54) COMPENSATION FOR GAS TURBINE ENGINE FUEL VALVE CHARACTERISTICS

(71) Applicant: SOLAR TURBINES INCORPORATED, San Diego, CA (US)

(72) Inventors: Chad M. Holcomb, San Diego, CA (US); Saliha Kenyon Lacoursiere, San Diego, CA (US); Roy Thomas Collins, San Diego, CA (US)

(73) Assignee: Solar Turbines Incorporated, San Diego, CA (US)

(21) Appl. No.: 13/852,691

(22) Filed: Mar. 28, 2013

(51) Int. Cl. F02C 9/26

(52) U.S. Cl. CPC F02C 9/26
USPC 60/772; 60/39.281

(57) ABSTRACT

A method for operating a gas turbine engine fuel system with a fuel control valve is disclosed. The method includes metering fuel through the fuel control valve with an effective flow area versus command data set. The method also includes detecting that a change in an effective flow area of the fuel control valve has occurred. The method further includes modifying the effective flow area versus command data set to reflect the detected change in the effective flow area of the fuel control valve.

### TECHNICAL FIELD

The present disclosure generally pertains to gas turbine engines, and is more particularly directed toward a compensation for gas turbine engine fuel valve characteristics.

### BACKGROUND

Gas turbine engines include compressor, combustor, and turbine sections. A fuel system delivers fuel to the combustor fuel nozzles. An external gas compressor may supply the pressure to the fuel system and control valves may be used to regulate the amount of fuel delivered to the fuel nozzles. The gas fuel flow rate may be approximated or inferred by the fuel system during operation of the gas turbine engine.

U.S. patent publication No. 2010/0280731 to D. Snider discloses systems and methods for controlling fuel flow to a turbine component. One or more parameters associated with a fuel flow to a turbine component may be monitored. The fuel flow may be modeled based at least in part on the one or more monitored parameters. The fuel flow may be adjusted to a target fuel flow based at least in part on the modeling of the fuel flow.

The present disclosure is directed toward overcoming one or more of the problems discovered by the inventors.

### SUMMARY OF THE DISCLOSURE

A method for operating a gas turbine engine fuel system with a fuel control valve is disclosed. The method includes metering fuel through the fuel control valve with an effective flow area versus command data set. The method also includes detecting that a change in an effective flow area of the fuel control valve has occurred. The method further includes modifying the effective flow area versus command data set to reflect the detected change in the effective flow area of the fuel control valve.

A control system for controlling a fuel system of a gas turbine engine having a fuel control valve and a flow sensor downstream of the fuel control valve is also disclosed. The control system includes a fuel control module, a flow module, and an effective flow area compensation module. The fuel control module is configured to determine a fuel control valve flow rate and operating position, and to send a command signal to the fuel control valve to position the fuel control valve in the operating position based on an effective flow area versus command data set. The flow module is configured to receive a flow sensor signal and to determine a flow sensor flow rate. The effective flow area compensation module is configured to receive the flow sensor flow rate and the command signal, to determine an actual effective flow area of the fuel control valve relative to the command signal, and to determine a correction for the effective flow area versus command data set.

### BRIEF DESCRIPTION OF THE DRAWINGS

FIG. 1 is a schematic illustration of an exemplary gas turbine engine and fuel system.

FIG. 2 is a schematic diagram of the fuel system of FIG. 1.

FIG. 3 is a schematic diagram for the effective flow area compensation of a control valve of the fuel system of FIG. 2.

### DETAILED DESCRIPTION

The systems and methods disclosed herein include a method for determining the control valve effective flow area. In embodiments, the gas turbine engine fuel system relies on the effective flow area versus command characteristic of the control valves to determine the flow rate of the fuel. Contamination, corrosion, as well as valve faults/wiring can affect the actual effective flow area. A flow measurement device, such as a venturi, may be used to measure the fuel flow rate. The actual or estimated actual effective flow area may be determined by comparing the flow sensor flow rate to the determined control valve flow rate. The effective flow area versus command characteristic may then be updated with the determined value.

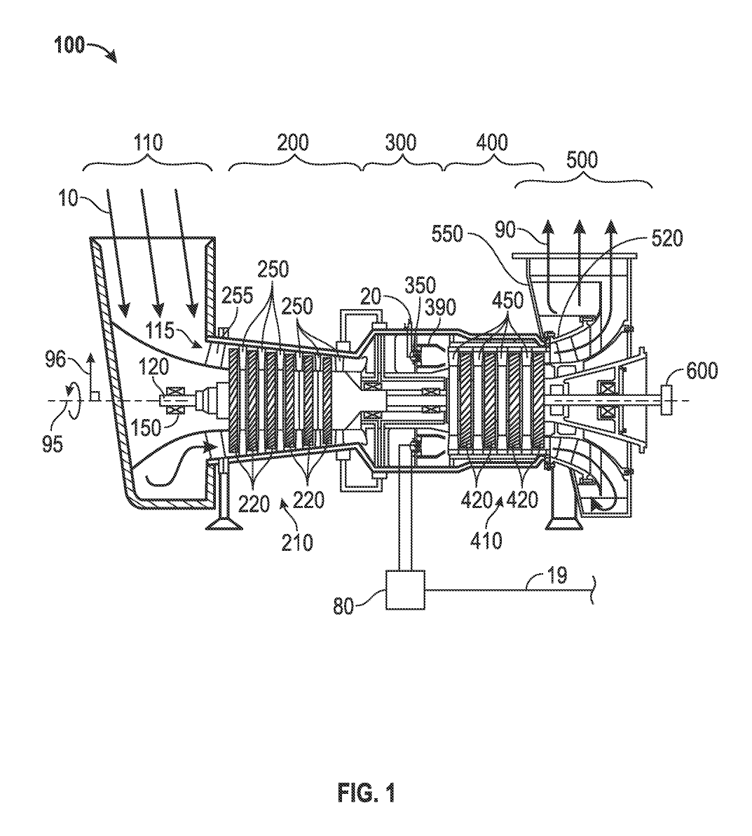

FIG. 1 is a schematic illustration of an exemplary gas turbine engine and fuel system. Some of the surfaces and components have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with other engine concentric components. All references to radial, axial, and circumferential directions and measures refer to center axis 95, unless specified otherwise. The terms such as “inner” and “outer” generally indicate a lesser or greater radial distance from the center axis 95. A radial 96 may be in any direction perpendicular and radiating outward from center axis 95.

A gas turbine engine 100 includes an inlet 110, a shaft 120, a gas producer or “compressor” section 200, a combustor 300, a turbine section 400, an exhaust 500, and a power output coupling 600. The gas turbine engine 100 may have a single shaft or a multiple shaft configuration.

The compressor section 200 includes a compressor rotor assembly 210, compressor stationary vanes (“stators”) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. A compressor stage includes a compressor disk assembly 220 paired with the adjacent stators 250 that follow the compressor disk assembly 220. Compressor section 200 includes multiple compressor stages. Inlet guide vanes 255 axially precede the fixed compressor stages. The inlet guide vanes 255 may be variable guide vanes.

The combustor 300 includes one or more fuel injectors 350 and includes one or more combustion chambers 390. A fuel system 80 delivers pressurized fuel to fuel injectors 350. Fuel system 80 receives pressurized fuel from fuel supply line 19, which supplies pressurized liquid or gas fuel from a fuel source (not shown).

The turbine section 400 includes a turbine rotor assembly 410, and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. Turbine nozzles 450 axially precede each of the turbine disk assemblies 420. Each turbine disk assembly 420 paired with the adjacent turbine nozzles 450 that precede the turbine disk assembly 420 is considered a turbine stage. Turbine section 400 includes multiple turbine stages.

The exhaust 500 includes an exhaust diffuser 520 and an exhaust collector 550.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, Mb 98T, TMS alloys, and CMSX single crystal alloys.

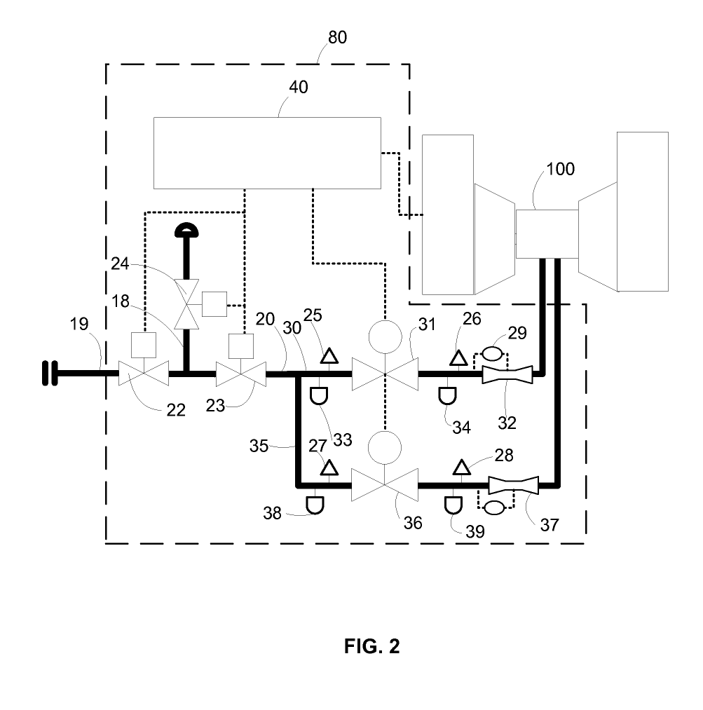

FIG. 2 is a schematic diagram of the fuel system 80 of FIG. 1 and the gas turbine engine 100. Pressurized gas fuel from fuel supply 19 travels along fuel line 20. Fuel line 20 may include block valves 22 and 23, with block valve 22 upstream of block valve 23. Vent line 18 may split or tee off from fuel line 20 between block valves 22 and 23. Vent line 18 may include vent valve 24.

Fuel line 20 may split into multiple fuel lines such as a primary fuel line 30 and a secondary fuel line 35. The split of fuel line 20 may be accomplished by fittings, manifolds, etc. In the embodiment shown in FIG. 2, fuel line 20 splits into primary fuel line 30 and secondary fuel line 35 after block valve 23.

Each of primary fuel line 30 and secondary fuel line 35 include one or more gas fuel control valves (“control valves”) and may include a flow meter such as a venturi. Any number of control valves may be included in fuel system 80 in both series and parallel configurations. In the embodiment shown, primary fuel line 30 includes primary control valve 31 and primary venturi 32, and secondary fuel line 35 includes secondary control valve 36 and secondary venturi 37. In some embodiments, a fuel line may include a primary control valve and a secondary control valve in series. Each fuel delivery line may also include sensing elements on either the upstream or downstream side of the fuel control valves. Exemplar sensors include pressure, temperature, and flow sensors. The downstream pressure and temperature sensors will be upstream of the flow sensor or venturi.

In the embodiment shown in FIG. 2, primary fuel line 30 includes upstream pressure sensor 33, downstream pressure sensor 34, upstream temperature sensor 25, and downstream temperature sensor 26; and secondary fuel line 35 includes upstream pressure sensor 38, downstream pressure sensor 39, upstream temperature sensor 27, and downstream temperature sensor 28. In some embodiments, primary fuel line 30 splits into primary fuel delivery lines after primary venturi 32, and secondary fuel line 35 splits into secondary fuel delivery lines after secondary venturi 37. Each split may be accomplished by fittings, manifolds, etc. Each fuel injector 350 (shown in FIG. 1) may be connected to a primary fuel delivery line and to a secondary fuel delivery line. Primary fuel delivery line may include one or more valves, and may connect to one or more fuel injector 350 ports. Similarly, secondary fuel delivery line may include one or more valves, and may connect to one or more fuel injector 350 ports. Other fuel delivery lines and configurations may also be used. In some embodiments, the secondary fuel line 35 is a pilot fuel line.

Fuel system 80 also includes control system 40. Control system 40 may include an electronic control circuit having a central processing unit (“CPU”), such as a processor, or micro controller. Alternatively, control system 40 may include programmable logic controllers or field-programmable gate arrays. Control system 40 may also include memory for storing computer executable instructions, which may be executed by the CPU. The memory may further store data related to controlling the fuel pressure and flow including the effective flow area versus command data of the control valves. Control system 40 also includes inputs and outputs to receive sensor signals and send control signals.

### INDUSTRIAL APPLICABILITY

Gas turbine engines may be suited for any number of industrial applications such as the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor section 200. In the compressor section 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500). Likewise, each turbine disk assembly 420 may be associated with a numbered stage.

Once air 10 leaves the compressor section 200, it enters the diffuser and then combustor 300 and fuel is added. Compressed air 10 and fuel are injected into the combustion chamber 390 via injector 350 and combusted. Energy is extracted from the combustion reaction via the turbine section 400 by each stage of the series of turbine disk assemblies 420. Exhaust gas 90 may then be diffused in exhaust diffuser 520, collected and redirected. Exhaust gas 90 exits the system via an exhaust collector 550 and may be further processed (e.g., to reduce harmful emissions, and/or to recover heat from the exhaust gas 90).

Referring to FIG. 2, during operation of gas turbine engine 100, control system 40 calculates the required supply pressure at the control valve to maintain turbine speed and load. Control system 40 has information regarding the fuel demand, fuel characteristics, fuel pressures upstream of the control valve(s) and downstream of the control valve(s), and the control valve characteristics, such as the effective flow area versus command data. Control system 40 may also have information about the required flows and pressures into the gas turbine engine to maintain combustion stability or to determine a set point for a desired increase in load. Control system 40 determines the control valve(s) position and may change the position and effective flow area of the control valve(s) by communicating or transmitting a control signal or command to the control valve(s).

In the embodiment shown in FIG. 2, control system 40 communicates control signals to primary control valve 31 and secondary control valve 36. Using the available information, control system 40 can limit and control fuel delivery.

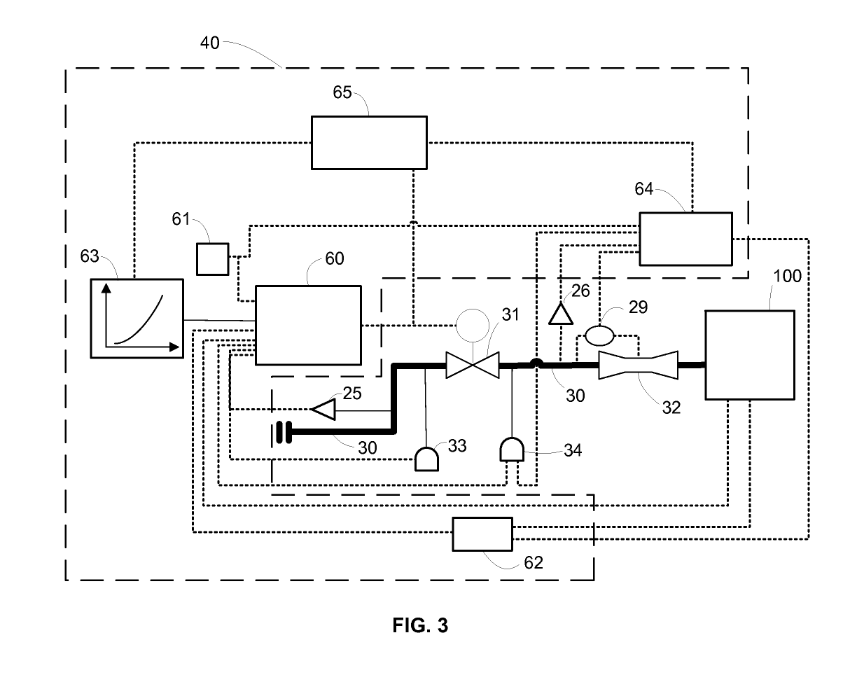

FIG. 3 is a schematic diagram for the effective flow area (“Cda”) compensation of a single control valve of the fuel system of FIG. 2 for a single flow path. While FIG. 3 illustrates the Cda compensation along primary flow path 30, the Cda compensation disclosed is not limited to use with primary flow path 30 and may be used in conjunction with other fuel lines such as secondary flow path 35 (shown in FIG. 2). All discussion of primary control valve 31 may apply to secondary control valve 36 and other fuel control valves.

The control system 40 may include a fuel control module 60, a flow module 64, a Cda compensation module 65, and a maximum fuel limit module 62. The control system 40 may also include Cda versus command data 63 of primary control valve 31 and fuel characteristics 61 of the fuel being used by the gas turbine engine 100.

In the embodiment shown in FIG. 3, the fuel control module 60 receives information such as the fuel characteristics 61, feedback from gas turbine engine 100, including data from the maximum fuel limit module 62, the upstream pressure from upstream pressure sensor 33, the downstream pressure from downstream pressure sensor 34, the upstream temperature from upstream temperature sensor 25, and the Cda versus command data 63. The fuel characteristics 61 may include the Boltzmann constant, the lower heating value, and the specific gravity of the fuel. The feedback may include the speed of the gas producer and the speed of the power turbine (in a dual shaft configuration). The fuel control module 60 uses this information to calculate or determine a fuel flow rate (“control valve flow”), such as a volumetric fuel flow rate, to determine the fuel flow rate to the fuel injectors 350 (shown in FIG. 1) and to determine an operating position of primary control valve 31.

The fuel control module 60 then sends a command signal to position primary control valve 31 into the operating position, which may include positioning primary control valve 31. In one embodiment, fuel control module 60 is performed by a programmable logic controller (“PLC”). Direct measurement of the fuel flow rate to the fuel injectors 350 may reduce the speed of response of the system, which is not always desirable.

The actual Cda of primary control valve 31 may be different than the nominal Cda of primary control valve 31 due to manufacturing degrade, contamination build up, corrosion, component mechanical degradation, and other valve faults. Pressure drops across primary control valve 31 may cause the contamination, such as sulfur deposition to occur over time. The difference between actual Cda and nominal Cda can affect the relationship between Cda and command. The nominal Cda may be provided by the manufacturer or determined prior to putting primary control valve 31 into service.

A flow sensor, such as a primary venturi 32 is used to correct or calibrate the Cda versus command data of primary control valve 31. Flow module 64 uses fuel characteristics 61 and the differential pressure 29 measured by the flow sensor to calculate or determine a measured fuel flow rate (“venturi flow”), such as a volumetric flow rate, to determine the actual fuel flow rate to the fuel injectors 350 (shown in FIG. 1). Flow module 64 may also use the downstream pressure from downstream pressure sensor 34 and the downstream temperature from downstream temperature sensor 26. Flow module 64 determines the venturi flow relative to the operating position of primary control valve 31 or relative to the command signal. Flow module 64 measures the venturi flow when primary control valve 31 is in the determined operating position.

The upstream pressure sensor 33 may send an upstream pressure signal, the downstream pressure sensor 34 may send a downstream pressure signal, the upstream temperature sensor 25 may send an upstream temperature signal, the downstream temperature sensor 26 may send a downstream temperature signal, and the flow sensor may send a flow sensor signal. The fuel control module 60, the flow module 64, the Cda compensation module 65, and the maximum fuel limit module 62 may be configured to receive the upstream pressure signal, the downstream pressure signal, the upstream temperature signal, the downstream temperature signal, and the flow meter signal.

The flow module 64 sends the venturi flow to the Cda compensation module 65. The Cda compensation module 65 uses the venturi flow to determine or estimate the actual Cda of primary control valve 31 relative to the command signal and operating position of primary control valve 31. The same algorithm used by fuel control module 60 to determine the control valve flow may be inverted and used by the Cda compensation module 65 to estimate the corrected Cda based off of the venturi flow. The Cda compensation module 65 may also compare the control valve flow to the venturi flow to determine the corrected Cda. The Cda compensation module 65 may update, modify, correct, or replace the Cda versus command data 63 to calibrate or recalibrate primary control valve 31, which may improve the accuracy of fuel control module 60.

In one embodiment, operating the fuel system 80 includes positioning the primary control valve 31 in an operating position, calibrating or recalibrating the Cda versus command data 63, and utilizing the calibrated Cda to control primary control valve 31. The Cda versus command data 63 may be the nominal Cda versus command data or the previously calibrated Cda versus command data. Calibrating or recalibrating the Cda versus command data 63 includes measuring the fuel flow downstream of primary control valve 31 with a flow sensor such as primary venturi 32 when primary control valve 31 is in the operating position, determining a calibrated Cda of primary control valve 31 in the operating position using the measured flow, and modifying the Cda versus command data 63 based on the calibrated Cda of primary control valve 31 during operation of the gas turbine engine 100.

In another embodiment, operating the fuel system 80 includes metering a fuel through primary control valve 31 using the Cda versus command data 63, detecting that a change in the Cda has occurred, and compensating for the detected change by altering or modifying the Cda versus command data 63 to reflect the detected change. The Cda versus command data 63 may include the nominal Cda values or the previously compensated Cda values, which may be stored for use when metering primary control valve 31. Detecting that a change in the Cda has occurred includes measuring a fuel flow downstream of primary control valve 31 with a flow sensor, determining a corrected Cda, and comparing the corrected Cda to a stored Cda in the Cda versus command data. Modifying the Cda versus command data 63 includes replacing the stored Cda value with the corrected Cda value.

Calibrating, recalibrating, or compensating the Cda versus command data 63 is performed multiple times during an operating cycle of gas turbine engine 100. In embodiments, calibrating or recalibrating the Cda versus command data 63 is performed at a predetermined interval, such as multiple times per minute.

Calibrating, recalibrating, or compensating the Cda versus command data 63 may be performed on a continuous loop during an operating cycle of gas turbine engine 100. In embodiments, the continuous loop occurs by repeating each portion or sub-element of calibrating or recalibrating the Cda versus command data 63 in order and by measuring the fuel flow downstream of primary control valve 31 after modifying the Cda versus command data 63. In other embodiments the continuous loop occurs by repeating each portion or sub-element of calibrating or recalibrating the Cda versus command data 63 in order with multiple loops occurring simultaneously.

Contamination or corrosion may occur over a significantly longer time period than times associated with engine transient operations. The Cda compensation module 65 can be performed using a slow speed of response and can be highly filtered. The Cda compensation module 65 may include a compensation filter. Filtering the Cda compensation module 65 may prevent or reduce any interference the Cda compensation module 65 may cause and may ensure that the correction is smooth to ensure fuel control stability.

In some operating conditions contaminants such as sulfur deposits may detach from the primary control valve 31 or reabsorb into the fuel stream in a short time frame. When contaminant detachment or reabsorption is detected the Cda compensation module 65 may be configured to recalibrate the Cda versus command data 63 quicker than when a contaminant build up is detected, or may be configured to reset the calibrated Cda versus command data back to the nominal Cda versus command data. The filtering applied to the Cda compensation module 65 may be skipped or bypassed when detachment of contaminants is detected. In one embodiment, a moving average or filtered error between the control valve flow and the venturi flow may be used to detect a detachment of contaminants; if the error changes by a predetermined amount, the Cda compensation module 65 resets or quickly recalibrates the Cda versus command data 63.

Those of ordinary skill in the art will appreciate that the various illustrative logical blocks, modules, controllers, units, and algorithms described in connection with the embodiments disclosed herein can often be implemented as electronic hardware, computer software, or combinations of both. To clearly illustrate this interchangeability of hardware and software, various illustrative components, units, blocks, modules, and operations have been described above generally in terms of their functionality. Whether such functionality is implemented as hardware or software depends upon the particular system and design constraints imposed on the overall system. Persons of ordinary skill in the art can implement the described functionality in varying ways for each particular system, but such implementation decisions should not be interpreted as causing a departure from the scope of the invention. In addition, the grouping of functions within a unit, module, block or operation is for ease of description. Specific functions or operations can be moved from one unit, module or block without departing from the invention. Electronic content may include, for example, but is not limited to, data and/or applications which may be accessed through the system or systems.

The various illustrative logical blocks, units, operations and modules described in connection with the example embodiments disclosed herein, may be implemented or performed with, for example, but not limited to, a processor, such as a general purpose processor, a digital signal processor (“DSP”), an application-specific integrated circuit (“ASIC”), a field programmable gate array (“FPGA”) or other programmable logic devices, such as a PLC, discrete gate or transistor logic, discrete hardware components, or any combination thereof designed to perform the functions described herein. A general-purpose processor may be, for example, but not limited to, a microprocessor, but in the alternative, the processor may be any processor, controller, or microcontroller. A processor may also be implemented as a combination of computing devices, for example, but not limited to, a combination of a DSP and a microprocessor, a plurality of microprocessors, one or more microprocessors in conjunction with a DSP core, or any other such configuration.

The operations of a method or algorithm and the processes of a block or module described in connection with the example embodiments disclosed herein may be embodied directly in hardware, in a software module (or unit) executed by a processor, or in a combination of the two. A software module may reside in, for example, but not limited to, random access memory (“RAM”), flash memory, read-only memory (“ROM”), erasable programmable read only memory (EPROM), electrically erasable programmable read only memory (“EEPROM”), registers, hard disk, a removable disk, a compact disk (“CD-ROM”), or any other form of machine or non-transitory computer readable storage medium. An exemplary storage medium may be coupled to the processor such that the processor can read information from, and write information to, the storage medium. In the alternative, the storage medium may be integral to the processor. The processor and the storage medium may reside in an ASIC.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular gas turbine engine fuel system, it will be appreciated that the fuel system in accordance with this disclosure can be implemented in various other configurations, can be used with various other types of gas turbine engines, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A method for operating a gas turbine engine fuel system with a fuel control valve, the method comprising:
metering fuel through the fuel control valve with an effective flow area versus command data set;
detecting that a change in an effective flow area of the fuel control valve has occurred; and
modifying the effective flow area versus command data set to reflect the detected change in the effective flow area of the fuel control valve.

2. The method of claim 1, wherein detecting that a change in the effective flow area of the fuel control valve includes measuring a fuel flow downstream of the fuel control valve with a flow sensor, determining a corrected effective flow area of the fuel control valve, and comparing the corrected effective flow area of the fuel control valve to a stored effective flow area in the effective flow area versus command data set.

3. The method of claim 2, wherein modifying the effective flow area versus command data set includes replacing the stored effective flow area with the corrected effective flow area.

4. The method of claim 2, wherein the fuel flow is measured with a venturi.

5. The method of claim 2, wherein measuring the fuel flow with a flow sensor includes determining a fuel flow rate.

6. The method of claim 5, wherein determining the fuel flow rate includes measuring a temperature of the fuel downstream of the fuel control valve and measuring a pressure of the fuel downstream of the fuel control valve.

7. A control system for controlling a fuel system of a gas turbine engine having a fuel control valve and a flow sensor downstream of the fuel control valve, the control system comprising:
a fuel control module configured to determine a fuel control valve flow rate and operating position, and to send a command signal to the fuel control valve to position the fuel control valve in the operating position based on an effective flow area versus command data set;
a flow module configured to receive a flow sensor signal and to determine a flow sensor flow rate; and
an effective flow area compensation module configured to receive the flow sensor flow rate and the command signal, to determine an actual effective flow area of the fuel control valve relative to the command signal, and to determine a correction for the effective flow area versus command data set.

8. The control system of claim 7, wherein the effective flow area compensation module is configured to update the effective flow area versus command data set to include the actual effective flow area of the fuel control valve for the command signal received.

9. The control system of claim 7, wherein the effective flow area compensation module is configured to filter the determined actual effective flow area with a low pass filter prior to determining the correction for the effective flow area versus command data set.

10. The control system of claim 7, wherein the flow module is configured to receive the flow sensor signal from a venturi.

11. The control system of claim 7, wherein the flow module is configured to receive a downstream temperature signal from a temperature sensor downstream of the fuel control valve, a downstream pressure signal from a pressure sensor downstream of the fuel control valve, and fuel characteristics to determine the flow sensor flow rate.

12. The control system of claim 11, wherein the flow module is configured to determine a secondary control valve operating position based on a ratio between the flow sensor flow rate and a secondary flow sensor flow rate.

13. The control system of claim 12, wherein the secondary control valve is a pilot control valve.

14. A method for operating a gas turbine engine fuel system with a fuel control valve, the method comprising:
positioning the fuel control valve in an operating position;
calibrating an effective flow area versus command data set multiple times during an operating cycle of the gas turbine engine, calibrating the effective flow area versus command data set including
measuring a fuel flow downstream of the fuel control valve with a flow sensor when the fuel control valve is in the operating position,
determining a corrected effective flow area of the fuel control valve in the operating position using the measured fuel flow, and
modifying an effective flow area versus command data set based on the corrected effective flow area of the fuel control valve; and
utilizing the corrected effective flow area to control the fuel control valve.

15. The method of claim 14, wherein the fuel flow is measured with a venturi.

16. The method of claim 14, wherein measuring the fuel flow with a flow sensor includes determining a fuel flow rate.

17. The method of claim 16, wherein determining the fuel flow rate includes measuring a temperature of the fuel downstream of the fuel control valve and measuring a pressure of the fuel downstream of the fuel control valve.

18. The method of claim 14, wherein determining the corrected effective flow area of the fuel control valve includes a compensation filter.

19. The method of claim 14, wherein positioning the fuel control valve in an operating position includes sending a command to the fuel control valve and modifying the effective flow area versus command data set is also based on the command sent to the fuel control valve.

20. The method of claim 14, further comprising:
positioning a secondary fuel control valve in a secondary operating position;
calibrating a secondary effective flow area versus command data set multiple times during an operating cycle of the gas turbine engine, calibrating the secondary effective flow area versus command data set including
measuring a secondary fuel flow downstream of the secondary fuel control valve with a secondary flow sensor when the secondary fuel control valve is in the secondary operating position,
determining a secondary corrected effective flow area of the secondary fuel control valve in the secondary operating position using the secondary measured fuel flow, and
modifying a secondary effective flow area versus command data set based on the secondary corrected effective flow area of the secondary fuel control valve; and
utilizing the secondary corrected effective flow area to control the fuel control valve.
